(19) United States
(12) Patent Application Publication
(10) Pub. No.: US 2022/0417991 A1
(43) Pub. Date: Dec. 29, 2022

(54) METHOD AND APPARATUS OF LICENSED ASSISTED ACCESS OVER AIR INTERFACE

(71) Applicant: Samsung Electronics Co., Ltd., Suwon-si (KR)

(72) Inventor: Emad N. Farag, Flanders, NJ (US)

(21) Appl. No.: 17/805,853

(22) Filed: Jun. 7, 2022

Related U.S. Application Data
(60) Provisional application No. 63/214,008, filed on Jun. 23, 2021.

(51) Int. Cl. H04W 74/08; H04W 72/04; H04L 1/18; H04L 5/00

(52) U.S. Cl. CPC H04W 74/0808; H04W 72/0406; H04L 1/1812; H04L 5/0037

(57) ABSTRACT

Apparatuses and methods for licensed assisted access over an air interface in a wireless communication system. A method of operating a user equipment (UE) includes determining a slot for a sidelink (SL) transmission of a first physical sidelink shared channel (PSSCH) based on a sensing and listen-before-talk (LBT) operation on a first air interface. The first air interface is for unlicensed spectrum. The method further includes transmitting, on the first air interface, the first PSSCH and receiving, on a second air interface, a first physical sidelink feedback channel (PSFCH) with HARQ-ACK information in response to the first PSSCH. The second air interface is for licensed spectrum.

### CROSS-REFERENCE TO RELATED APPLICATIONS AND CLAIM OF PRIORITY

The present application claims priority to U.S. Provisional Patent Application No. 63/214,008, filed on Jun. 23, 2021. The content of the above-identified patent documents are incorporated herein by reference.

### TECHNICAL FIELD

The present disclosure relates generally to wireless communication systems and, more specifically, the present disclosure relates to a licensed assisted access over an air interface in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a licensed assisted access over an air interface in a wireless communication system.

In one embodiment, a user equipment (UE) is provided. The UE includes a transceiver configured to receive and transmit on a first air interface and receive and transmit on a second air interface. The first air interface is for unlicensed spectrum. The second air interface is for licensed spectrum. The UE further includes a processor operably coupled to the transceiver. The processor is configured to determine a slot for a sidelink (SL) transmission of a first physical sidelink shared channel (PSSCH) based on a sensing and listen-before-talk (LBT) operation on the first air interface. The transceiver is further configured to transmit, on the first air interface, the first PSSCH and receive, on the second air interface, a first physical sidelink feedback channel (PSFCH) with HARQ-ACK information in response to the first PSSCH.

In another embodiment, a method of operating a UE is provided. The method includes determining a slot for a SL transmission of a first PSSCH based on a sensing and LBT operation on a first air interface. The first air interface is for unlicensed spectrum. The method further includes transmitting, on the first air interface, the first PSSCH and receiving, on a second air interface, a first PSFCH with HARQ-ACK information in response to the first PSSCH. The second air interface is for licensed spectrum.

In yet another embodiment, a base station (BS) is provided. The BS includes a transceiver configured to receive and transmit on a first air interface. The first air interface is for unlicensed spectrum. The BS further includes a processor operably coupled to the transceiver. The processor is configured to determine a slot for a SL transmission of a PSSCH for a UE. The transceiver is further configured to perform, on the first air interface, a LBT operation and, if the LBT operation is successful, transmit a downlink control information (DCI) format to the UE with information about the SL transmission of the PSSCH.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of available spectrums for SL data transmission according to embodiments of the present disclosure;

FIG. 7A illustrates a flowchart of method for UE procedure to embodiments of the present disclosure;

FIG. 7B illustrates an example of SL data transmission over the unlicensed spectrum according to embodiments of the present disclosure;

FIG. 8 illustrates another example of SL data transmission over the unlicensed spectrum according to embodiments of the present disclosure;

FIG. 9 illustrates an example of first SL data transmission over the unlicensed spectrum according to embodiments of the present disclosure;

FIG. 10 illustrates another example of first SL data transmission over the unlicensed spectrum according to embodiments of the present disclosure;

FIG. 11 illustrates yet another example of first SL data transmission over the unlicensed spectrum according to embodiments of the present disclosure;

FIG. 12 illustrates an example of available spectrums for SL data transmission and Uu interface according to embodiments of the present disclosure;

FIG. 13A illustrates a flowchart of method for an eNB or UE according to embodiments of the present disclosure;

FIG. 13B illustrates an example of the SL synchronization channels are transmitted over licensed/ITS spectrum according to embodiments of the present disclosure; and

FIG. 14 illustrates yet another example of SL data transmission over the unlicensed spectrum according to embodiments of the present disclosure.

### DETAILED DESCRIPTION

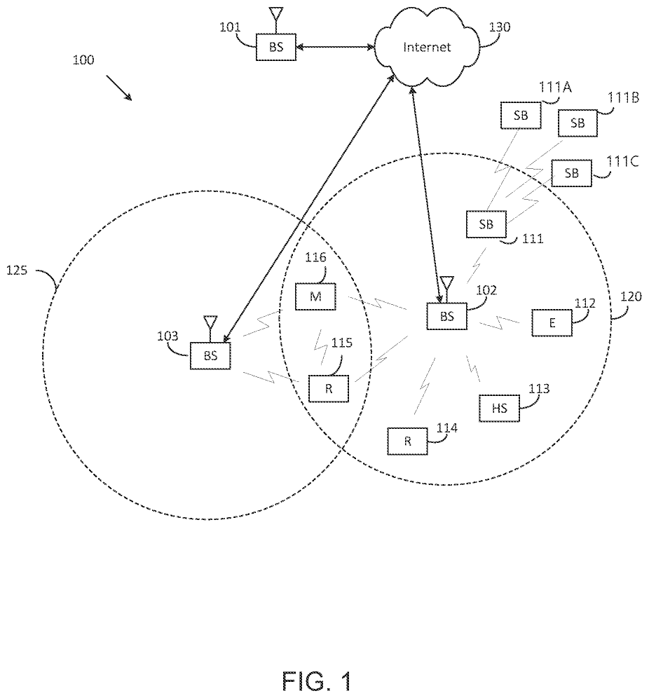

FIG. 1 through FIG. 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v17.1.0, “NR; Physical channels and modulation”; 3GPP TS 38.212 v17.1.0, “NR; Multiplexing and Channel coding”; 3GPP TS 38.213 v17.1.0, “NR; Physical Layer Procedures for Control”; 3GPP TS 38.214 v17.1.0, “NR; Physical Layer Procedures for Data”; 3GPP TS 38.321 v17.0.0, “NR; Medium Access Control (MAC) protocol specification”; and 3GPP TS 38.331 v17.0.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of UEs within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In various embodiments, a UE 116 may communicate with another UE 115 via a sidelink (SL). For example, both UEs 115-116 can be within network coverage (of the same or different base stations). In another example, the UE 116 may be within network coverage and the other UE may be outside network coverage (e.g., UEs 111A-111C). In some embodiments, the UEs 111A-111C may use a device to device (D2D) interface called PC5 (e.g., also known as sidelink at the physical layer) for communication. In yet another example, both UE are outside network coverage. In some embodiments, one or more of the gNBs 101-103 may communicate with each other and with the UEs 111-116 using 5G/NR, LTE, LTE-A, WiMAX, WiFi, or other wireless communication techniques. In yet another example, SBs 111A to 111C can communicate with another of the SBs 111A to 111C.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for licensed assisted access over an air interface in a wireless communication system. In certain embodiments, and one or more of the gNBs 101-103 includes circuitry, programing, or a combination thereof, for licensed assisted access over an air interface in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

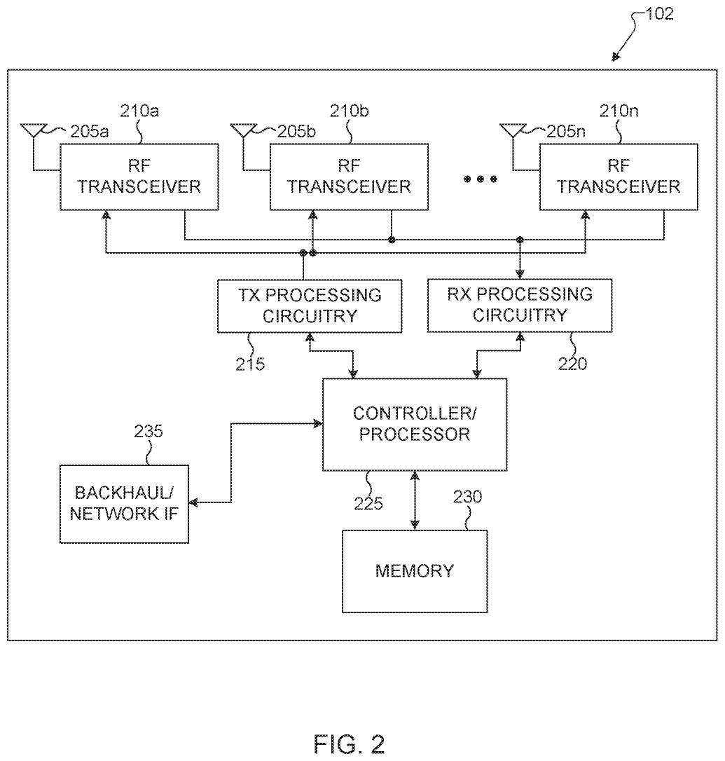

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support a licensed assisted access over an air interface in a wireless communication system. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

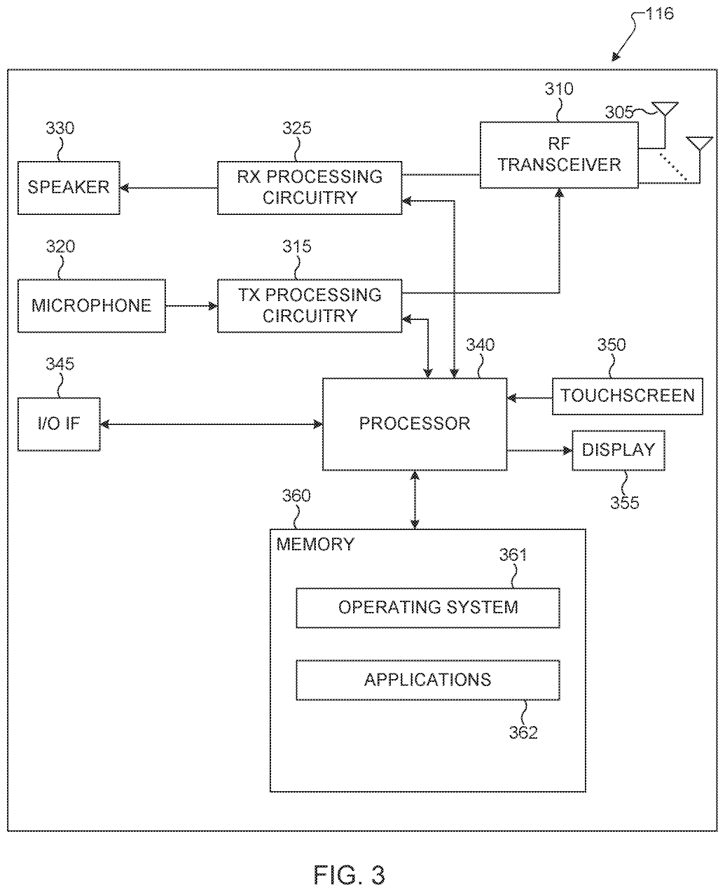

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and RX processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100, or by another UE on SL. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of DL channels and signals or SL channels and signals and the transmission of UL channels and signals or SL channel and signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for a licensed assisted access over an air interface in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

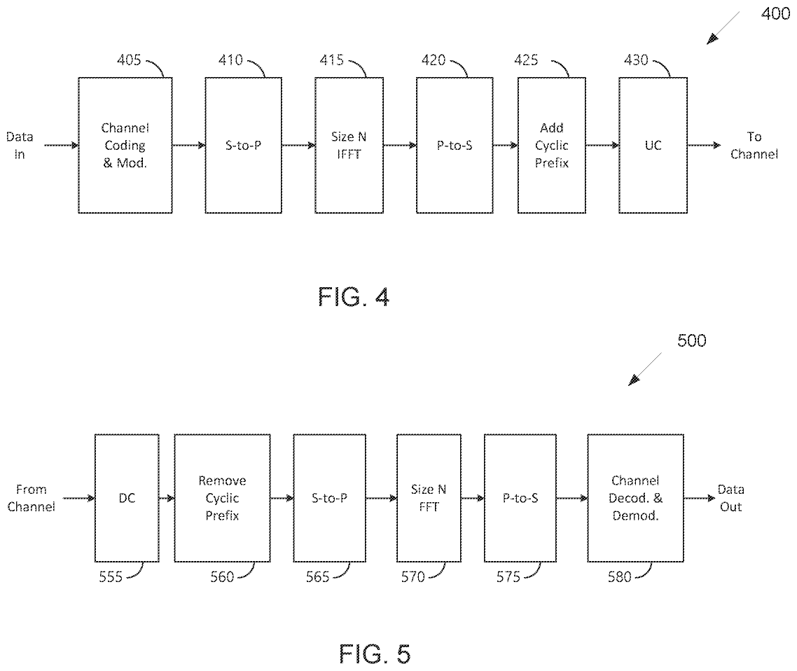

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. It may also be understood that the receive path 500 can be implemented in a first UE and that the transmit path 400 can be implemented in a second UE to support SL communications. In some embodiments, the receive path 500 is configured to support SL sensing in SL communication and listen-before-talk (LBT) operation on unlicensed spectrum as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. A transmitted RF signal from a first UE arrives at a second UE after passing through the wireless channel, and reverse operations to those at the first UE are performed at the second UE.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and/or transmitting in the sidelink to another UE and may implement the receive path 500 for receiving in the downlink from the gNBs 101-103 and/or receiving in the sidelink from another UE.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems (see also REF 1). In addition, a slot can have symbols for SL communications. A UE can be configured one or more bandwidth parts (BWPs) of a system BW for transmissions or receptions of signals or channels.

SL signals and channels are transmitted and received on sub-channels within a resource pool, where a resource pool is a set of time-frequency resources used for SL transmission and reception within a SL BWP. SL channels include physical SL shared channels (PSSCHs) conveying data information, physical SL control channels (PSCCHs) conveying SL control information (SCI) for scheduling transmissions/receptions of PSSCHs, physical SL feedback channels (PSFCHs) conveying hybrid automatic repeat request acknowledgement (HARQ-ACK) information in response to correct (ACK value) or incorrect (NACK value) transport block receptions in respective PSSCHs, and physical SL broadcast channel (PSBCH) conveying system information to assist in SL synchronization.

SL signals include demodulation reference signals (DM-RS) or sidelink demodulation-reference signals that are multiplexed in PSSCH or PSCCH transmissions to assist with data or SCI demodulation, channel state information reference signals (CSI-RS) for channel measurements, phase tracking reference signals (PT-RS) for tracking a carrier phase, and SL primary synchronization signals (S-PSS) and SL secondary synchronization signals (S-SSS) for SL synchronization. SCI can include two parts/stages corresponding to two respective SCI formats where, for example, the first SCI format is multiplexed on a PSCCH, and the second SCI format is multiplexed along with SL data on a PSSCH that is transmitted in physical resources indicated by the first SCI format.

An SL channel can operate in different cast modes. In a unicast mode, a PSCCH/PSSCH conveys SL information from one UE to only one other UE. In a groupcast mode, a PSCCH/PSSCH conveys SL information from one UE to a group of UEs within a (pre-) configured set. In a broadcast mode, a PSCCH/PSSCH conveys SL information from one UE to all surrounding UEs. In NR release 16, there are two resource allocation modes for a PSCCH/PSSCH transmission. In resource allocation mode 1, a gNB schedules a UE on the SL and conveys scheduling information to the UE transmitting on the SL through a DCI format transmitted to the gNB on the DL (e.g., DCI Format 3_0) transmitted from the gNB on DL. In resource allocation mode 2, a UE schedules a SL transmission. SL transmissions can operate within network coverage where each UE is within the communication range of a gNB, outside network coverage where all UEs have no communication with any gNB, or with partial network coverage, where only some UEs are within the communication range of a gNB.

In case of groupcast PSCCH/PSSCH transmission, a UE can be (pre-)configured one of two options for reporting of HARQ-ACK information by the UE.

In one example of HARQ-ACK reporting option (1), a UE can attempt to decode a transport block (TB) in a PSSCH reception if, for example, the UE detects a SCI format scheduling the TB reception through a corresponding PSSCH. If the UE fails to correctly decode the TB, the UE multiplexes a negative acknowledgement (NACK) in a PSFCH transmission. In this option, the UE does not transmit a PSFCH with a positive acknowledgment (ACK) when the UE correctly decodes the TB.

In another example of HARQ-ACK reporting option (2), a UE can attempt to decode a TB if, for example, the UE detects a SCI format that schedules a corresponding PSSCH. If the UE correctly decodes the TB, the UE multiplexes an ACK in a PSFCH transmission; otherwise, if the UE does not correctly decode the TB, the UE multiplexes a NACK in a PSFCH transmission.

In HARQ-ACK reporting option (1), when a UE that transmitted the PSSCH detects a NACK in a PSFCH reception, the UE can transmit another PSSCH with the TB (retransmission of the TB). In HARQ-ACK reporting option (2) when a UE that transmitted the PSSCH does not detect an ACK in a PSFCH reception, such as when the UE detects a NACK or does not detect a PSFCH reception, the UE can transmit another PSSCH with the TB.

A sidelink resource pool includes a set/pool of slots and a set/pool of RBs used for sidelink transmission and sidelink reception. A set of slots which can belong to a sidelink resource pool can be denoted by {t₀^{SL}, t₁^{SL}, t₂^{SL}, . . . }. A set of slots which belong to a resource pool can be denoted by {t′₀^{SL}, t′₁^{SL}, t′₂^{SL}, . . . , t′_{T′}_{_{MAX}}₋₁^{SL}} and can be configured, for example, at least using a bitmap. Where, T′_{MAX} is the number of SL slots in a resource pool with 1024 frames. Within each slot t′_{y}^{SL} of a sidelink resource pool, there are N_{subCH} contiguous sub-channels in the frequency domain for sidelink transmission, where N_{subCH} is provided by a higher-layer parameter. Subchannel m, where m is between 0 and N_{subCH}−1, is given by a set of n_{subCHsize} PRBs, given by n_{PRB}=n_{subCHstart}+m·n_{subCHsize}+j, where j=0, 1, . . . , n_{subCHsize}−1; n_{subCHstart} and n_{subCHsize} are provided by higher layer parameters.

The slots of a SL resource pool are determined as following examples.

In one example, Let a set of slots that may belong to a resource be denoted by {t₀^{SL}, t₁^{SL}, t₂^{SL}, . . . , t_{T}_{_{MAX}}₋₁^{SL}}, where 0≤tᵢ^{SL}<10240×2^{μ}, and 0≤i<T_{MAX}, μ is the sub-carrier spacing configuration. μ=0 for a 15 kHz sub-carrier spacing. μ=1 for a 30 kHz sub-carrier spacing. μ=2 for a 60 kHz sub-carrier spacing. μ=8 for a 120 kHz sub-carrier spacing. The slot index is relative to slot #0 of SFN #0 of the serving cell, or DFN #0. The set of slots includes all slots except: (1) N_{S-SSB} slots that are configured for SL SS/PBCH Block (S-SSB); (2) N_{nonSL} slots where at least one SL symbols is not semi-statically configured as UL symbol by higher layer parameter tdd-UL-DL-ConfigurationCommon or sl-TDD-Configuration. In a SL slot, OFDM symbols Y-th, (Y+1)-th, . . . , (Y+X−1)-th are SL symbols, where Y is determined by the higher layer parameter sl-StartSymbol and X is determined by higher layer parameter sl-LengthSymbols; and (3) N_{reserved} reserved slots. Reserved slots are determined such that the slots in the set {t₀^{SL}, t₁^{SL}, t₂^{SL}, . . . , t_{T}_{_{MAX}}₋₁^{SL}} is a multiple of the bitmap length (L_{bitmap}), where the bitmap (b₀, b₁, b_{L}_{_{bitmap}}₋₁) is configured by higher layers.

The reserved slots are determined as follows: (1) let {l₀, l₁, . . . , l₂_{^{μ}}_{×10240-N}_{_{S-SSB}}_{-N}_{_{nonSL}}₋₁} be the set of slots in range 0 . . . 2^{μ}×10240−1, excluding S-SSB slots and non-SL slots. The slots are arranged in ascending order of the slot index; (2) the number of reserved slots is given by: N_{reserved}=(2^{μ}×10240−N_{S-SSB}−N_{nonSL}) mod L_{bitmap}; and (3) the reserved slots lᵣ are given by:

$$r = ⌊ \frac{m \cdot ( {2}^{μ} \times 10240 - {N}_{S - SSB} - {N}_{n o n S L} )}{{N}_{reserved}} ⌋ ,$$

where, m=0, 1, . . . , N_{reserved}−1. Tₘₐₓ is given by: Tₘₐₓ=2^{μ}×10240−N_{S-SSB}−N_{nonSL}−N_{reserved}.

In another example, the slots are arranged in ascending order of slot index.

In yet another example, the set of slots belonging to the SL resource pool, {t′₀^{SL}, t′₁^{SL}, t′₂^{SL}, . . . , t′_{T′}_{_{MAX}}₋₁^{SL}} are determined as follows: (1) each resource pool has a corresponding bitmap (b₀, b₁, . . . , b_{L}_{_{bitmap}}₋₁) of length L_{bitmap}; (2) a slot tₖ^{SL} belongs to the resource pool if b_{k mod L}_{_{bitmap}}=1; and (3) the remaining slots are indexed successively staring from 0, 1, . . . T′_{MAX}−1. Where, T′_{MAX} is the number of remaining slots in the set.

Slots can be numbered (indexed) as physical slots or logical slots, wherein physical slots include all slots numbered sequential, while logical slots include only slots that belong to a sidelink resource pool as described above numbered sequentially. The conversion from a physical duration, Pᵣₛᵥₚ, in milli-second to logical slots, Pᵣₛᵥₚ′, is given by

$${P}_{rsvp}^{′} = ⌈ \frac{{T}_{max}^{′}}{10240 ms} \times {P}_{rsvp} ⌉ .$$

For resource (re-)selection or re-evaluation in slot n, a UE can determine a set of available single-slot resources for transmission within a resource selection window [n+T₁, n+T₂], such that a single-slot resource for transmission, R_{x,y} is defined as a set of L_{subCH} contiguous subchannels x+i, where i=0, 1, . . . , L_{subCH}−1 in slot t′_{y}^{SL}. T₁ is determined by the UE such that, 0≤T₁≤T_{proc,1}^{SL}, where T_{proc,1}^{SL} is a PSSCH processing time for example as defined in 3GPP standard specification, such as TS 38.214 Table 8.1.4-2. T₂ is determined by the UE such that T_{2 min}≤T₂<Remaining Packet Delay Budget, as long as T_{2 min}<Remaining Packet Delay Budget, else T₂ is equal to the Remaining Packet Delay Budget. T_{2 min} is a configured by higher layers and depends on the priority of the SL transmission.

The resource (re-)selection is a two-step procedure: (1) the first step (e.g., performed in the physical layer) is to identify the candidate resources within a resource selection window. Candidate resources are resources that belong to a resource pool, but exclude resources (e.g., resource exclusion) that were previously reserved, or potentially reserved by other UEs. The resources excluded are based on SCIs decoded in a sensing window and for which the UE measures a SL RSRP that exceeds a threshold. The threshold depends on the priority indicated in a SCI format and on the priority of the SL transmission. Therefore, sensing within a sensing window involves decoding the first stage SCI, and measuring the corresponding SL RSRP, wherein the SL RSRP can be based on PSCCH DMRS or PSSCH DMRS. Sensing is performed over slots where the UE does not transmit SL. The resources excluded are based on reserved transmissions or semi-persistent transmissions that can collide with any of reserved or semi-persistent transmissions. The identified candidate resources after resource exclusion are provided to higher layers; and (2) the second step (e.g., performed in the higher layers) is to select or re-select a resource from the identified candidate resources for PSSCH/PSCCH transmission.

During the first step of the resource (re-)selection procedure, a UE can monitor slots in a sensing window [n−T₀, n−T_{proc,0}^{SL}), where the UE monitors slots belonging to a corresponding sidelink resource pool that are not used for the UE's own transmission. For example, T_{proc,0}^{SL} is the sensing processing latency time, for example as defined in 3GPP standard specification, TS 38.214 Table 8.1.4-1. To determine a candidate single-slot resource set to report to higher layers, a UE excludes (e.g., resource exclusion) from the set of available single-slot resources for SL transmission within a resource pool and within a resource selection window, the following examples.

In one example, single slot resource R_{x,y}, such that for any slot t′ₘ^{SL} not monitored within the sensing window with a hypothetical received SCI Format 1-A, with a “Resource reservation period” set to any periodicity value allowed by a higher layer parameter sl-ResourceReservePeriodList and indicating all sub-channels of the resource pool in this slot, satisfies condition 2.2. below

In another example, single slot resource R_{x,y}, such that for any received SCI within the sensing window: (1) the associated L1-RSRP measurement is above a (pre-)configured SL-RSRP threshold, where the SL-RSRP threshold depends on the priority indicated in the received SCI and that of the SL transmission for which resources are being selected; and (2) (Condition 2.2) The received SCI in slot t′ₘ^{SL}, or if “Resource reservation field” is present in the received SCI the same SCI is assumed to be received in slot t′_{m+q×P}_{_{rsvp_Rx}}_{′}^{SL}, indicates a set of resource blocks that overlaps R_{x,y+j×P}_{_{rsvp_Tx}}_{′}.

Where: q=1, 2, . . . , Q, where, if P_{rsvp_RX}≤T_{scal} and n′−m<P_{rsvp_Rx}′→

$$Q = ⌈ \frac{{T}_{scal}}{{P}_{rsvp \_ RX}} ⌉ .$$

T_{scal} is T₂ in units of milli-seconds; Else Q=1; and if n belongs to (t′₀^{SL}, t′₁^{SL}, . . . , t′_{T′}_{ₘₐₓ}₋₁^{SL}), n′=n, else n′ is the first slot after slot n belonging to set (t′₀^{SL}, t′₁^{SL}, . . . , t′_{T′}_{ₘₐₓ}₋₁^{SL}).

Where: (1) j=0, 1, . . . , Cᵣₑₛₑₜ−1; (2) P_{rsvp_RX} is the indicated resource reservation period in the received SCI in physical slots, and P_{rsvp_RX}′ is that value converted to logical slots; and (3) P_{rsvp_Tx}′ is the resource reservation period of the SL transmissions for which resources are being reserved in logical slots.

In yet another example, if the candidate resources are less than a (pre-)configured percentage given by higher layer parameter sl_TxPrecentageList(prio_{TX}) that depends on the priority of the SL transmission prio_{TX}, such as 20%, of the total available resources within the resource selection window, the (pre-)configured SL-RSRP thresholds are increased by a predetermined amount, such as 3 dB.

NR SL introduced two new procedures for mode 2 resource allocation; re-evaluation and pre-emption.

Re-evaluation check occurs when a UE checks the availability of pre-selected SL resources before the resources are first signaled in an SCI Format, and if needed re-selects new SL resources. For a pre-selected resource to be first-time signaled in slot m, the UE performs a re-evaluation check at least in slot m−T₃.

The re-evaluation check includes: (1) performing the first step of the SL resource selection procedure as defined in 3GPP standard specification 38.214 (i.e., clause 8.1.4 of TS 38.214), which involves identifying a candidate (available) sidelink resource set in a resource selection window as previously described; (2) if the pre-selected resource is available in the candidate sidelink resource set, the resource is used/signaled for sidelink transmission; and (3) else, the pre-selected resource is not available in the candidate sidelink resource set, a new sidelink resource is re-selected from the candidate sidelink resource set.

Pre-emption check occurs when a UE checks the availability of pre-selected SL resources that have been previously signaled and reserved in an SCI Format, and if needed re-selects new SL resources. For a pre-selected and reserved resource to be signaled in slot m, the UE performs a pre-emption check at least in slot m−T₃.

The pre-emption check includes: (1) performing the first step of the SL resource selection procedure as defined in 3GPP standard specification (i.e., clause 8.1.4 of TS 38.214), which involves identifying candidate (available) sidelink resource set in a resource selection window as previously described; (2) if the pre-selected and reserved resource is available in the candidate sidelink resource set, the resource is used/signaled for sidelink transmission; (3) else, the pre-selected and reserved resource is NOT available in the candidate sidelink resource set. The resource is excluded from the candidate resource set due to an SCI, associated with a priority value P_{RX}, having an RSRP exceeding a threshold. Let the priority value of the SL resource being checked for pre-emption be P_{TX}.

If the priority value P_{RX} is less than a higher-layer configured threshold and the priority value P_{RX} is less than the priority value P_{TX}. The pre-selected and reserved SL resource is pre-empted. A new SL resource is re-selected from the candidate SL resource set. Note that, a lower priority value indicates traffic of higher priority. Else, the resource is used/signaled for SL transmission.

As described above, the monitoring procedure for resource (re)selection during the sensing window requires reception and decoding of a SCI format during the sensing window, as well as measuring the SL RSRP. This reception and decoding process and measuring the SL RSRP increases a processing complexity and power consumption of a UE for sidelink communication. The aforementioned sensing procedure is referred to a full sensing.

Rel-17 introduced low-power resource allocation. Low-power resource allocation schemes include partial sensing and random resource selection. If a SL transmission from a UE is periodic, partial sensing can be based on periodic-based partial sensing (PBPS), and/or contiguous partial sensing (CPS). If a SL transmission from a UE is aperiodic, partial sensing can be based on CPS and PBPS if the resource pool supports periodic reservations (i.e., sl_multiReserveResource is enabled). When a UE performs PBPS, the UE selects a set of Y slots (Y≥Yₘᵢₙ) within a resource selection window corresponding to PBPS, where Yₘᵢₙ is provided by higher layer parameter minNumCandidateSlotsPeriodic . . . . The UE monitors slots at t′_{y-k×P}_{ᵣₑₛₑᵣᵥₑ}^{SL}, where t′_{y}^{SL} is a slot of the Y selected candidate slots. The periodicity value for sensing for PBPS, i.e., Pᵣₑₛₑᵣᵥₑ is a subset of the resource reservation periods allowed in a resource pool provided by higher layer parameter sl-ResourceReservePeriodList. Pᵣₑₛₑᵣᵥₑ is provided by higher layer parameter periodicSensingOccasionReservePeriodList, if not configured, Pᵣₑₛₑᵣᵥₑ includes all periodicities in sl-ResourceReservePeriodList. The UE monitors k sensing occasions determined by additionalPeriodicSensingOccasion, as previously described, and not earlier than n−T₀. For a given periodicity Pᵣₑₛₑᵣᵥₑ, the values of k correspond to the most recent sensing occasion earlier than t′_{y0}^{SL}−(T_{proc,0}^{SL}+T_{proc,1}^{SL}) if additionalPeriodicSensingOccasion is not (pre-)configured, and additionally includes the value of k corresponding to the last periodic sensing occasion prior to the most recent one if additionalPeriodicSensingOccasion is (pre-)configured. t′_{y0}^{SL} is the first slot of the selected Y candidate slots of PBPS. When a UE performs CPS, the UE selects a set of Y′ slots (Y′≥Y′ₘᵢₙ) within a resource selection window corresponding to CPS, where Yₘᵢₙ is provided by higher layer parameter minNumCandidateSlotsAperiodic. The sensing window for CPS starts at least M logical slots before t′_{y0}^{SL} (the first of the Y′ candidate slots) and ends at t′_{y0}^{SL}−(T_{proc,0}^{SL}+T_{proc,1}^{SL}).

Rel-17 introduced inter-UE co-ordination (IUC) to enhance the reliability and reduce the latency for resource allocation, where SL UEs exchange information with one another over sidelink to aid the resource allocation mode 2 (re-)selection procedure. UE-A provides information to UE-B, and UE-B uses the provided information for its resource allocation mode 2 (re-)selection procedure. IUC addresses is designed to address issues with distributed resource allocation such as: (1) Hidden node problem, where a UE-B is transmitting to a UE-A and UE-B can't sense or detect transmissions from a UE-C that interfere with its transmission to a UE-A, (2) Exposed node problem, where a UE-B is transmitting to a UE-A, and UE-B senses or detects transmissions from a UE-C and avoids the resources used or reserved by UE-C, but UE-C doesn't cause interference at UE-A, (3) Persistent collision problem, and (4) Half-duplex problem, where UE-B is transmitting to a UE-A in the same slot that UE-A is transmitting. UE-A will miss the transmission from UE-B as UE-A cannot receive and transmit in the same slot.

There are two schemes for inter-UE co-ordination.

In one example, in scheme 1, a UE-A can provide to another UE-B indications of resources that are preferred to be included in UE-B's (re-)selected resources or non-preferred resources to be excluded for UE-B's (re-) selected resources. When given preferred resources, UE-B may use only on those resources for its resource (re-)selection, or UE-B may combine them with resources identified by its own sensing procedure, by finding the intersection of the two sets of resources, for its resource (re-)selection. When given non-preferred resources, UE-B may exclude these resources from resources identified by its own sensing procedure for its resource (re-) selection. Transmissions of co-ordination information (e.g., IUC messages) sent by UE-A to UE-B, and co-ordination information requests for (e.g., IUC requests) sent by UE-B to UE-A, are sent in a MAC-CE message and may also, if the supported by the UE, be sent in a 2^{nd}-stage SCI Format (SCI Format 2-C). The benefit of using the 2nd stage SCI is to reduce latency. IUC messages from UE-A to UE-B can be sent standalone, or can be combined with other SL data. Coordination information (IUC messages) can be in response to a request from UE-B, or due to a condition at UE-A. An IUC request is unicast from UE-B to UE-A, in response UE-A sends an IUC message in unicast mode to UE-B. An IUC message transmitted as a result of an internal condition at UE-A can be unicast to UE-B, when the IUC message includes preferred resources, or can be unicast, groupcast or broadcast to UE-B when the IUC message includes non-preferred resources. UE-A can determine preferred or non-preferred resources for UE-B based on its own sensing taking into account the SL-RSRP measurement of the sensed data and the priority of the sensed data, i.e., the priority field of the decoded PSCCH during sensing as well as the priority the traffic transmitted by UE-B in case of request-based IUC or a configured priority in case of condition-based IUC. Non-preferred resource to UE-B can also be determined to avoid the half-duplex problem, where, UE-A can't receive data from a UE-B in the same slot UE-A is transmitting.

In another example, in scheme 2, a UE-A can provide to another UE-B an indication that resources reserved for UE-B's transmission, whether or not UE-A is the destination UE, are subject to conflict with a transmission from another UE. UE-A determines the conflicting resources based on the priority and RSRP of the transmissions involved in the conflict. UE-A can also determine a presence of a conflict due to the half-duplex problem, where UE-A can't receive a reserved resource from UE-B at the same time UE-A is transmitting. When UE-B receives a conflict indication for a reserved resource, the UE-B can re-select new resources to replace them.

The conflict information from UE-A is sent in a PSFCH channel separately (pre-) configured from the PSFCH of the PSFCH of SL-HARQ operation. The timing of the PSFCH channel carrying conflict information can be based on the SCI indicating reserved resource, or based on the reserved resource

In both schemes, UE-A can identify resources according to a number of conditions which are based on the SL-RSRP of the resources in question as a function of the traffic priority, and/or whether UE-A would be unable to receive a transmission from UE-B, due to performing its own transmission, i.e., a half-duplex problem. The purpose of this exchange of information is to give UE-B information about resource occupancy acquired by UE-A which UE-B might not be able to determine on its own due to hidden nodes, exposed nodes, persistent collisions, etc.

In Rel-16, procedures for operation of NR Uu interface over unlicensed spectrum targeting frequencies to around 7 GHz are developed. In unlicensed spectrum the NR radio access technology (RAT) is shared with other radio access technologies such as WiFi. To ensure fair access to the spectrum by the different technologies' procedures are in place for channel access. In NR when operating over unlicensed spectrum, the intended transmitters listen to the air interface to ensure that no other user is accessing the channel before the transmitter starts to transmit. This procedure is known as listen-before-talk (LBT).

One of the features of operation in unlicensed spectrum is channel occupancy time (COT) sharing. In one example, the gNB initializes a COT and shares the COT with its UEs. In this example, the gNB is the Initiating Device, the UEs of the gNB are the Responding Devices. The COT can have one or multiple switching points between DL and UL. If the DL-UL gap is less than 16 microseconds (μs), the UE can transmit for up to 584 μs without sensing, if the DL-UL gap is 16 μs, the UE can transmit after 16 μs of sensing, if the DL-UL gap is 25 μs, the UE can transmit after 25 μs of sensing. If the UL-DL gap is less than 16 μs, the gNB can transmit for up to 584 μs without sensing, if the UL-DL gap is 16 μs, the gNB can transmit after 16 μs of sensing, if the UL-DL gap is 25 μs, the gNB can transmit after 25 μs of sensing.

In another example, the UE initializes a COT and shares the COT with its gNB. In this example, the UE is the Initiating Device, the gNB is the Responding Devices. The COT can have one switching point from UL to DL. If the UL-DL gap is less than 16 μs, the gNB can transmit for up to 584 μs without sensing, if the UL-DL gap is 16 μs, the gNB can transmit after 16 μs of sensing, if the UL-DL gap is 25 μs, the gNB can transmit after 25 μs of sensing.

In Rel-16 and Rel-17, SL operates over licensed spectrum and intelligent transport service (ITS) spectrum. To support higher data rates expected for new sidelink applications, which exceeds 1 Gbps it is expected that new spectrum may be used. Given the scarcity of licensed and ITS spectrum, it seems that unlicensed spectrum is a promising option for supporting SL with higher data rates.

In the present disclosure, apparatus and methods are provided for supporting SL operation in unlicensed spectrum.

3GPP Release 16 is the first NR release to include sidelink through work item “5G V2X with NR sidelink,” the mechanisms introduced mainly focused on vehicle-to-everything (V2X) and can be used for public safety when the service requirement can be met. Release 17 extends sidelink support to more use cases through work item “NR Sidelink enhancement” targeting low power operation and enhanced reliability and reduced latency. In Release 18, it is expected that SL may be expanded to support new applications that require support of high data rates. Using more bandwidth is one approach to increase the data rate.

Rel-16 and Rel-17 support NR SL operation over licensed and ITS spectrum, given the scarcity of licensed and ITS spectrum, unlicensed spectrum may be a good spectrum type to use for SL in Rel-18 to increase the SL spectrum. Unlicensed spectrum is shared with other radio access technologies (e.g., WiFi), and regulations require channel access procedures that ensure fair sharing of this spectrum. In the present disclosures, apparatus and methods are provided for supporting SL operation in unlicensed spectrum.

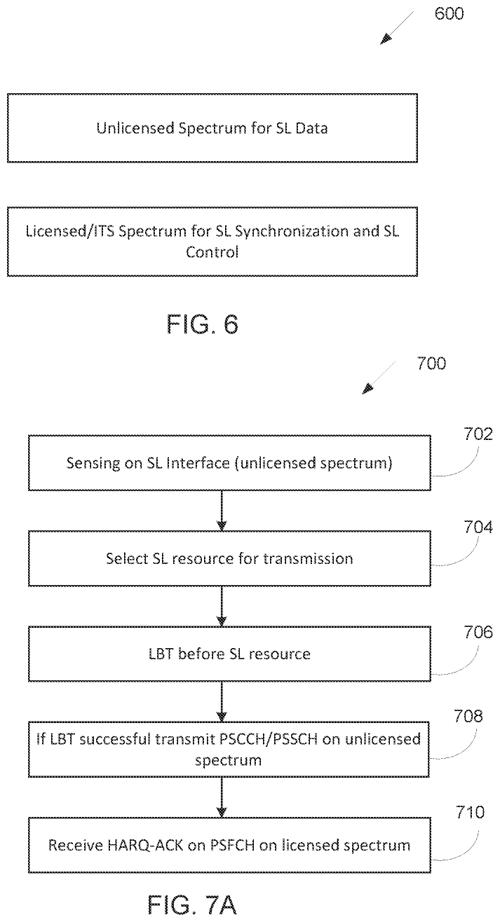

FIG. 6 illustrates an example of available spectrums for SL data transmission 600 according to embodiments of the present disclosure. An embodiment of the available spectrums for SL data transmission 600 shown in FIG. 6 is for illustration only.

As illustrated in FIG. 6, there are two types of spectrums available, unlicensed spectrum which is shared with other radio access technologies such WiFi; the second type of spectrum is licensed spectrum and ITS spectrum, generically referred to as licensed spectrum. Rel-16 and Rel-17 SL procedures target operation of SL in licensed spectrum and ITS spectrum.

In the present disclosure, two spectrums are provided: (1) using unlicensed spectrum for SL data transmissions to have access to larger bandwidth and support higher data rates; and (2) using licensed/ITS spectrum for transmission of SL synchronization channels such as S-PSS, S-SSS and/or PSFCH. Licensed/ITS spectrum can also be used for SL control information as described in other examples in this disclosure. Operation over licensed/ITS spectrum is more controlled and hence can provide better reliability for synchronization and control channels and critical information on the SL shared channel such as inter-UE coordination information and inter-UE coordination requests.

In one example, SL data (e.g., PSCCH/PSSCH) is transmitted over the unlicensed spectrum, the SL HARQ feedback on PSFCH is transmitted over unlicensed spectrum. The SL synchronization channels are transmitted over licensed/ITS spectrum.

In one example, SL data (e.g., PSCCH/PSSCH) is transmitted over the unlicensed spectrum, there is no HARQ feedback, e.g., the UE can use blind retransmissions, and, in this case, there is no PSFCH transmission for HARQ-ACK. The SL synchronization channels are transmitted over licensed/ITS spectrum.

In one example, SL data (e.g., PSCCH/PSSCH) is transmitted over the unlicensed spectrum, the SL HARQ feedback on PSFCH is transmitted over unlicensed spectrum. The SL synchronization channels are transmitted over licensed/ITS spectrum. In one example, conflict information is provided on PSFCH: (1) in one sub-example, PSFCH transmission is on licensed/ITS spectrum; and (2) in one sub-example, PSFCH transmission is on unlicensed spectrum.

In one example, SL data (e.g., PSCCH/PSSCH) is transmitted over the unlicensed spectrum, there is no HARQ feedback, e.g., the UE can use blind retransmissions, and, in this case, there is no PSFCH transmission for HARQ-ACK. The SL synchronization channels are transmitted over licensed/ITS spectrum. In one example, conflict information is provided on PSFCH: (1) in one sub-example, PSFCH transmission is on licensed/ITS spectrum; and (2) in one sub-example, PSFCH transmission is on unlicensed spectrum.

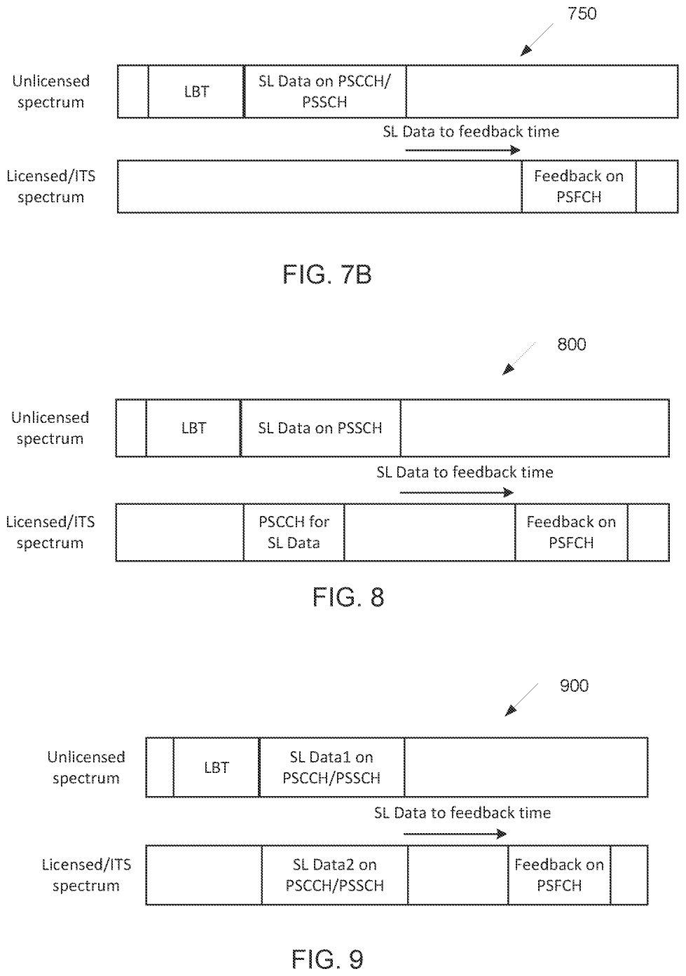

FIG. 7A illustrates a flowchart of method for UE 700 according to embodiments of the present disclosure. The method 700 as may be performed by a UE (e.g., 111-116 as illustrated in FIG. 1. An embodiment of the method 700 shown in FIG. 7A is for illustration only. One or more of the components illustrated in FIG. 7A can be implemented in specialized circuitry configured to perform the noted functions or one or more of the components can be implemented by one or more processors executing instructions to perform the noted functions.

As illustrated in FIG. 7A, an example of processing in UE for transmission of SL information over the unlicensed spectrum is illustrated.

In one example of Step 1 (e.g., 702), the UE performs sensing over the unlicensed spectrum. Sensing can be full sensing, or partial sensing (which includes periodic based partial sensing (PBPS) and/or contiguous partial sensing (CPS)) or no sensing (e.g., random resource selection). The UE determines candidate single-slot SL resources within a resource selection window.

In one example of Step 2 (e.g., 704), the UE selects a SL resource for transmission on the unlicensed spectrum, from the single-slot SL candidate resources identified in step 1.

In one example of Step 3 (e.g., 706), the UE performs LBT before the SL resource.

In one example of Step 4 (e.g., 708), if the LBT is successful, the UE transmits (PSCCH/PSSCH) in the unlicensed spectrum on the SL resource.

In one example of Step 5 (e.g., 710), the UE receives HARQ-ACK feedback in a corresponding PSFCH in the licensed spectrum.

FIG. 7B illustrates an example of SL data transmission over the unlicensed spectrum 750 according to embodiments of the present disclosure. An embodiment of the SL data transmission over the unlicensed spectrum 750 shown in FIG. 7B is for illustration only.

As illustrated in FIG. 7B, SL data (e.g., PSCCH/PSSCH) is transmitted over the unlicensed spectrum, the SL HARQ feedback on PSFCH is transmitted over licensed/ITS spectrum.

The UE performs sensing over the unlicensed spectrum within a sensing window. The UE determines candidate SL resources within a resource selection window after performing resource exclusion as described earlier in this disclosure. The UE selects a SL resource for SL transmission within the candidate SL resources. Sensing performed can be full sensing, or partial sensing (which includes periodic based partial sensing (PBPS) and/or contiguous partial sensing (CPS)) or no sensing (e.g., random resource selection). Before transmission over the unlicensed spectrum the UE accesses the channel by performing listen-before-talk (LBT) operation. If the channel is available, the UE transmits SL data including PSCCH and the corresponding PSSCH over the unlicensed spectrum in the selected SL resource. A UE receiving the SL transmission provides HARQ feedback on PSFCH over the licensed/ITS spectrum to the UE transmitting the SL transmission.

In one example, there is no HARQ feedback, e.g., the UE can use blind retransmissions, and, in this case, there is no PSFCH transmission for HARQ-ACK on licensed/ITS spectrum.

In one example, conflict information is provided on PSFCH: (1) in one sub-example, PSFCH transmission is on licensed/ITS spectrum; and (2) in one sub-example, PSFCH transmission is on unlicensed spectrum.

In one example of FIG. 7B, the SL synchronization channels are transmitted over licensed/ITS spectrum. In one example, there is no transmission of SL synchronization channels, the synchronization is provided by GNSS or by the network (gNB/eNB). In one example, the SL synchronization channels are transmitted over unlicensed spectrum.

FIG. 8 illustrates another example of SL data transmission over the unlicensed spectrum 800 according to embodiments of the present disclosure. An embodiment of the SL data transmission over the unlicensed spectrum 800 shown in FIG. 8 is for illustration only.

In another example in FIG. 8, SL data (e.g., PSSCH) is transmitted over the unlicensed spectrum, the SL HARQ feedback on PSFCH is transmitted over licensed/ITS spectrum.

The UE performs sensing over the unlicensed spectrum within a sensing window. The UE determines candidate SL resources within a resource selection window after performing resource exclusion as described earlier in this disclosure. The UE selects a SL resource for SL transmission within the candidate SL resources. Sensing performed can be full sensing, or partial sensing (which includes periodic based partial sensing (PBPS) and/or contiguous partial sensing (CPS)) or no sensing (e.g., random resource selection). Before transmission over the unlicensed spectrum the UE accesses the channel by performing LBT operation. If the channel is available, the UE transmits the PSCCH associated with SL data on licensed/ITS spectrum. The UE transmits the SL data on PSSCH over the unlicensed spectrum in the selected SL resource.

In one example, the UE additionally performs sensing on the licensed spectrum for the PSCCH. Sensing performed can be full sensing, or partial sensing (which includes periodic based partial sensing (PBPS) and/or contiguous partial sensing (CPS)) or no sensing (e.g., random resource selection). The UE determines candidate resources within a resource selection window for PSCCH. The UE selects a SL resource for transmission of PSCCH. In one example, the resource selected for PSCCH is in the same slot as the resource selected for PSSCH. In one example, the resource selected for PSCCH is earlier than the resource selected for PSSCH. In one example, the resource selected for PSCCH is no later than the resource selected for PSSCH.

The UE provides HARQ feedback on PSFCH over the licensed/ITS spectrum.

In one example, there is no HARQ feedback, e.g., the UE can use blind retransmissions, and, in this case, there is no PSFCH transmission for HARQ-ACK on licensed/ITS spectrum.

The processing in the UE is similar to the processing illustrated in FIG. 7A, except that: (1) PSCCH is transmitted in licensed spectrum; and (2) there can be additional sensing and resource selection for PSCCH in the licensed spectrum.

In one example of FIG. 8, the SL synchronization channels are transmitted over licensed/ITS spectrum. In one example, there is no transmission of SL synchronization channels, the synchronization is provided by GNSS or by the network (gNB/eNB). In one example, the SL synchronization channels are transmitted over unlicensed spectrum.

FIG. 9 illustrates an example of first SL data transmission over the unlicensed spectrum 900 according to embodiments of the present disclosure. An embodiment of the first SL data transmission over the unlicensed spectrum 900 shown in FIG. 9 is for illustration only.

In another example in FIG. 9, a first SL data is transmitted over the unlicensed spectrum, a second SL data is transmitted over licensed/ITS spectrum, the SL HARQ feedback on PSFCH is transmitted over licensed/ITS spectrum. In one example, the first data can correspond to high-speed data, and the second data can correspond to data with a higher reliability requirement.

The UE performs sensing over the unlicensed spectrum within a sensing window. The UE determines candidate SL resources within a resource selection window after performing resource exclusion as described earlier in this disclosure. The UE selects a SL resource for SL transmission within the candidate SL resources. Sensing performed can be full sensing, or partial sensing (which includes periodic based partial sensing (PBPS) and/or contiguous partial sensing (CPS)) or no sensing (e.g., random resource selection). Before transmission over the unlicensed spectrum of the first SL data the UE accesses the channel by performing LBT operation. If the channel is available, the UE transmits the first SL data including PSCCH and the corresponding PSSCH over the unlicensed spectrum in the selected SL resource.

The UE performs sensing over the licensed spectrum within a sensing window. The UE determines candidate SL resources within a resource selection window after performing resource exclusion as described earlier in this disclosure. The UE selects a SL resource for SL transmission of second PSCCH/PSSCH within the candidate SL resources. Sensing performed can be full sensing, or partial sensing (which includes periodic based partial sensing (PBPS) and/or contiguous partial sensing (CPS)) or no sensing (e.g., random resource selection). The UE transmits the second data over licensed/ITS spectrum. This is independent of the LBT operation and therefore can be transmitted whether or not the first data is transmitted.

The UE provides HARQ feedback on PSFCH over the licensed/ITS spectrum for both the first SL data (if transmitted) and the second SL data. In one example, the UE provides HARQ feedback on PSFCH over the unlicensed spectrum for the first SL data (if transmitted) and the UE provides HARQ feedback on PSFCH over the licensed/ITS spectrum for the second SL data. In a variant example, the UE provides HARQ feedback on PSFCH over the unlicensed spectrum for both the first SL data (if transmitted) and the second SL data.

In one example, the second SL data (e.g., second PSSCH) can include inter-UE co-ordination (IUC) related information. For example, the second PSSCH can include IUC message with preferred and/or non-preferred resources from a UE-A to a UE-B. The IUC message can be based on a trigger from UE-B, or based on an internal-cause (e.g., condition) at UE-A. In another example, the second PSSCH can include IUC request from UE-B to UE-A.

The processing in the UE is similar to the processing illustrated in FIG. 7A, except that: (1) a second PSCCH/PSSCH is transmitted in licensed spectrum, with the associated sensing and resource selection.

In one example, there is no HARQ feedback, e.g., the UE can use blind retransmissions, and, in this case, there is no PSFCH transmission for HARQ-ACK on licensed/ITS spectrum.

In another example, the SL HARQ feedback can be only for the first SL data or only for the second SL data.

In one example, conflict information is provided on PSFCH: (1) in one sub-example, PSFCH transmission is on licensed/ITS spectrum; (2) in one sub-example, PSFCH transmission is on unlicensed spectrum; and (3) in one sub-example, PSFCH transmission is on unlicensed spectrum for conflict information associated with the first SL data, and PSFCH transmission is on licensed/ITS spectrum for conflict information associated with the second SL data.

In one example of FIG. 9, the SL synchronization channels are transmitted over licensed/ITS spectrum. In one example, there is no transmission of SL synchronization channels, the synchronization is provided by GNSS or by the network (gNB/eNB). In one example, the SL synchronization channels are transmitted over unlicensed spectrum.

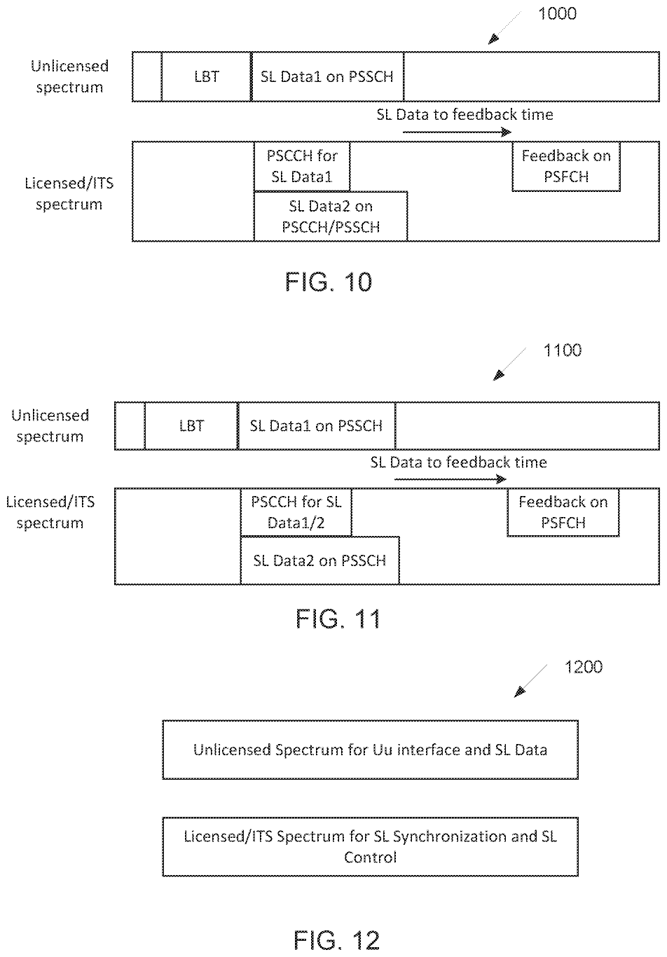

FIG. 10 illustrates another example of first SL data transmission over the unlicensed spectrum 1000 according to embodiments of the present disclosure. An embodiment of the first SL data transmission over the unlicensed spectrum 1000 shown in FIG. 10 is for illustration only.

In another example in FIG. 10, a first SL data (e.g., PSSCH) is transmitted over the unlicensed spectrum, a second SL data (e.g., second PSCCH/PSSCH) is transmitted over licensed/ITS spectrum, the SL HARQ feedback on PSFCH is transmitted over licensed/ITS spectrum.

The UE performs sensing over the unlicensed spectrum within a sensing window. The UE determines candidate SL resources within a resource selection window after performing resource exclusion as described earlier in this disclosure. The UE selects a SL resource for SL transmission within the candidate SL resources. Sensing performed can be full sensing, or partial sensing (which includes periodic based partial sensing (PBPS) and/or contiguous partial sensing (CPS)) or no sensing (e.g., random resource selection). Before transmission over the unlicensed spectrum of the first SL data the UE accesses the channel by performing LBT operation. If the channel is available, the UE transmits a first PSCCH associated with the first SL data on licensed/ITS spectrum. The UE transmits the first SL data on PSSCH over the unlicensed spectrum in the selected SL resource.

In one example, the UE additionally performs sensing on the licensed spectrum for the first PSCCH associated with first PSSCH. Sensing performed can be full sensing, or partial sensing (which includes periodic based partial sensing (PBPS) and/or contiguous partial sensing (CPS)) or no sensing (e.g., random resource selection). The UE determines candidate resources within a resource selection window for the first PSCCH. The UE selects a SL resource for transmission of the first PSCCH. In one example, the resource selected for the first PSCCH is in the same slot as the resource selected for the first PSSCH. In one example, the resource selected for the first PSCCH is earlier than the resource selected for the first PSSCH. In one example, the resource selected for the first PSCCH is no later than the resource selected for the first PSSCH.

The UE performs sensing over the licensed spectrum within a sensing window. The UE determines candidate SL resources within a resource selection window after performing resource exclusion as described earlier in this disclosure. The UE selects a SL resource for SL transmission of the second PSCCH/PSSCH within the candidate SL resources. Sensing performed can be full sensing, or partial sensing (which includes periodic based partial sensing (PBPS) and/or contiguous partial sensing (CPS)) or no sensing (e.g., random resource selection). The UE transmits the second data over licensed/ITS spectrum in the selected SL resource. This is independent of the LBT operation and therefore can be transmitted whether or not the first data is transmitted.

In one example, the first PSCCH and the second PSCCH/PSSCH can be transmitted in the same slot. In one example, the first PSCCH and the second PSCCH/PSSCH can be transmitted in different slots.

In one example, the sensing and resource selection for the first PSCCH and the second PSCCH/PSSCH in the licensed spectrum can be common to both.

The UE provides HARQ feedback on PSFCH over the licensed/ITS spectrum for both the first SL data (if transmitted) and the second SL data. In one example, the UE provides HARQ feedback on PSFCH over the unlicensed spectrum for the first SL data (if transmitted) and the UE provides HARQ feedback on PSFCH over the licensed/ITS spectrum for the second SL data. In a variant example, the UE provides HARQ feedback on PSFCH over the unlicensed spectrum for both the first SL data (if transmitted) and the second SL data.

In one example, the second SL data (e.g., second PSSCH) can include inter-UE co-ordination (IUC) related information. For example, the second PSSCH can include IUC message with preferred and/or non-preferred resources from a UE-A to a UE-B. The IUC message can be based on a trigger from UE-B, or based on an internal-cause (e.g., condition) at UE-A. In another example, the second PSSCH can include IUC request from UE-B to UE-A.

The processing in the UE is similar to the processing illustrated in FIG. 7A, except that: (1) first PSCCH is transmitted in licensed spectrum; (2) a second PSCCH/PSSCH is transmitted in licensed spectrum, with the associated sensing and resource selection; and (3) there can be additional sensing and resource selection for PSCCH and for the second PSCCH/PSSCH in the licensed spectrum.

In one example, there is no HARQ feedback, e.g., the UE can use blind retransmissions, and, in this case, there is no PSFCH transmission for HARQ-ACK on licensed/ITS spectrum.

In another example, the SL HARQ feedback can be only for the first SL data or only for the second SL data.

In one example, conflict information is provided on PSFCH: (1) in one sub-example, PSFCH transmission is on licensed/ITS spectrum; (2) in one sub-example, PSFCH transmission is on unlicensed spectrum; and (3) in one sub-example, PSFCH transmission is on unlicensed spectrum for conflict information associated with the first SL data, and PSFCH transmission is on licensed/ITS spectrum for conflict information associated with the second SL data.

In one example of FIG. 10, the SL synchronization channels are transmitted over licensed/ITS spectrum. In one example, there is no transmission of SL synchronization channels, the synchronization is provided by GNSS or by the network (gNB/eNB). In one example, the SL synchronization channels are transmitted over unlicensed spectrum.

FIG. 11 illustrates yet another example of first SL data transmission over the unlicensed spectrum 1100 according to embodiments of the present disclosure. An embodiment of the first SL data transmission over the unlicensed spectrum 1100 shown in FIG. 11 is for illustration only.

In another example in FIG. 11, a first SL data (e.g., PSSCH) is transmitted over the unlicensed spectrum, a second SL data (e.g., PSCCH/PSSCH) is transmitted over licensed/ITS spectrum, the SL HARQ feedback on PSFCH is transmitted over licensed/ITS spectrum.

The UE performs sensing over the unlicensed spectrum within a sensing window. The UE determines candidate SL resources within a resource selection window after performing resource exclusion as described earlier in this disclosure. The UE selects a SL resource for SL transmission within the candidate SL resources. Sensing performed can be full sensing, or partial sensing (which includes periodic based partial sensing (PBPS) and/or contiguous partial sensing (CPS)) or no sensing (e.g., random resource selection). Before transmission over the unlicensed spectrum of the first SL data the UE accesses the channel by performing LBT operation. If the channel is available, the UE transmits a first PSCCH associated with the first SL data on licensed/ITS spectrum. The UE transmits the first SL data on PSSCH over the unlicensed spectrum in the selected SL resource.

In one example, the UE additionally performs sensing on the licensed spectrum for the first PSCCH associated with first PSSCH. Sensing performed can be full sensing, or partial sensing (which includes periodic based partial sensing (PBPS) and/or contiguous partial sensing (CPS)) or no sensing (e.g., random resource selection). The UE determines candidate resources within a resource selection window for the first PSCCH. The UE selects a SL resource for transmission of the first PSCCH. In one example, the resource selected for the first PSCCH is in the same slot as the resource selected for the first PSSCH. In one example, the resource selected for the first PSCCH is earlier than the resource selected for the first PSSCH. In one example, the resource selected for the first PSCCH is no later than the resource selected for the first PSSCH.

The UE performs sensing over the licensed spectrum within a sensing window. The UE determines candidate SL resources within a resource selection window after performing resource exclusion as described earlier in this disclosure. The UE selects a SL resource for SL transmission of the second PSCCH/PSSCH within the candidate SL resources. Sensing performed can be full sensing, or partial sensing (which includes periodic based partial sensing (PBPS) and/or contiguous partial sensing (CPS)) or no sensing (e.g., random resource selection). The UE transmits the second data (e.g., second PSSCH) over licensed/ITS spectrum on the selected SL resource. This is independent of the LBT operation and therefore can be transmitted whether or not the first data is transmitted. In this example, if the first and second data are transmitted at the same time, the UE combines the PSCCH of the first SL data and the second SL data in a single PSCCH.

In one example, the first PSCCH associated with first PSSCH and the second PSCCH associated with second PSSCH are combined in to third PSCCH: (1) in one sub-example, the third PSCCH can be transmitted in the same slot of the second PSSCH; (2) in one sub-example, the third PSCCH can be transmitted in a slot earlier than the slot of the second PSSCH; and (3) in one sub-example, the third PSCCH can be transmitted in a slot no later than the slot of the second PSSCH. (4) in one sub-example, the third PSCCH can be transmitted in the same slot of the first PSSCH; (5) in one sub-example, the third PSCCH can be transmitted in a slot earlier than the slot of the first PSSCH; and (6) in one sub-example, the third PSCCH can be transmitted in a slot no later than the slot of the first PSSCH.

In one example, if the resource selected for the second PSSCH is in the same slot as the resource selected for the first PSSCH, the first PSCCH and the second PSCCH can be transmitted in the same slot. In one example, if the resource selected for the second PSSCH is earlier than the resource selected for the first PSSCH, the first PSCCH and the second PSCCH can be transmitted in the same slot. In one example, if the resource selected for the second PSSCH is no later than the resource selected for the first PSSCH, the first PSCCH and the second PSCCH can be transmitted in the same slot.

In one example, the sensing and resource selection for the first PSCCH and the second PSCCH/PSSCH in the licensed spectrum is common to both.

The UE provides HARQ feedback on PSFCH over the licensed/ITS spectrum for both the first SL data (if transmitted) and the second SL data. In one example, the UE provides HARQ feedback on PSFCH over the unlicensed spectrum for the first SL data (if transmitted) and the UE provides HARQ feedback on PSFCH over the licensed/ITS spectrum for the second SL data. In a variant example, the UE provides HARQ feedback on PSFCH over the unlicensed spectrum for both the first SL data (if transmitted) and the second SL data.

In one example, the second SL data (e.g., second PSSCH) can include inter-UE co-ordination (IUC) related information. For example, the second PSSCH can include IUC message with preferred and/or non-preferred resources from a UE-A to a UE-B. The IUC message can be based on a trigger from UE-B, or based on an internal-cause (e.g., condition) at UE-A. In another example, the second PSSCH can include IUC request from UE-B to UE-A.

The processing in the UE is similar to the processing illustrated in FIG. 7A, except that: (1) first PSCCH combined with a second PSCCH is transmitted in licensed spectrum; (2) a second PSSCH is transmitted in licensed spectrum, with the associated sensing and resource selection; and (3) there can be additional sensing and resource selection for the combined PSCCH (or first PSCCH) in the licensed spectrum, alternative the sensing and resource selection for the combined PSCCH (or first PSCCH) is common with the sensing and resource selection for the second PSSCH in the licensed spectrum.

In one example, there is no HARQ feedback, e.g., the UE can use blind retransmissions, and, in this case, there is no PSFCH transmission for HARQ-ACK on licensed/ITS spectrum.

In another example, the SL HARQ feedback can be only for the first SL data or only for the second SL data.

In one example, conflict information is provided on PSFCH: (1) in one sub-example, PSFCH transmission is on licensed/ITS spectrum; (2) in one sub-example, PSFCH transmission is on unlicensed spectrum; and (3) in one sub-example, PSFCH transmission is on unlicensed spectrum for conflict information associated with the first SL data, and PSFCH transmission is on licensed/ITS spectrum for conflict information associated with the second SL data.

In one example of FIG. 11, the SL synchronization channels are transmitted over licensed/ITS spectrum. In one example, there is no transmission of SL synchronization channels, the synchronization is provided by GNSS or by the network (gNB/eNB). In one example, the SL synchronization channels are transmitted over unlicensed spectrum.

FIG. 12 illustrates an example of available spectrums for SL data transmission and Uu interface 1200 according to embodiments of the present disclosure. An embodiment of the available spectrums for SL data transmission and Uu interface 1200 shown in FIG. 12 is for illustration only.

As illustrated in FIG. 12, there are two types of spectrums available, unlicensed spectrum which is shared with other radio access technologies such WiFi; the second type of spectrum is licensed spectrum and ITS spectrum, generically referred as licensed spectrum. Rel-16 and Rel-17 SL procedures target operation of SL in licensed spectrum and ITS spectrum, generically referred as licensed spectrum.

In the present disclosure, following spectrum are provided: (1) using unlicensed spectrum for SL data transmissions to have access to larger bandwidth and support higher data rates; (2) using licensed/ITS spectrum for transmission of SL synchronization channels such as S-PSS, S-SSS and/or PSFCH. Licensed/ITS spectrum can also be used for SL control information as described in other examples in this disclosure. Operation over licensed/ITS spectrum is more controlled and hence can provide better reliability for synchronization and control channels; and (3) In this component, the unlicensed spectrum is also used for the Uu interface between the UE and the gNB or the eNB.

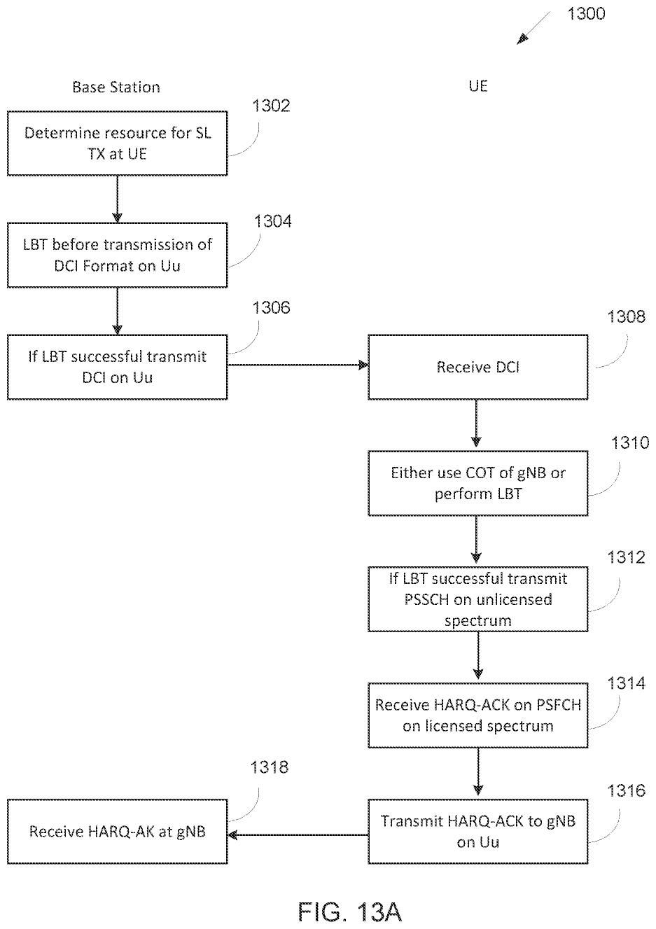

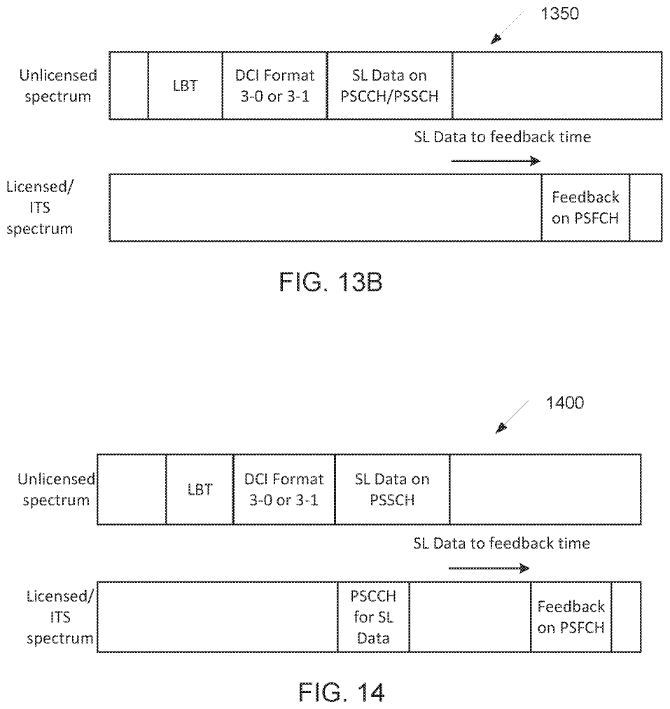

FIG. 13A illustrates a flowchart of method 1300 for a UE or gNB according to embodiments of the present disclosure. The method 1300 as may be performed by a UE (e.g., 111-116 as illustrated in FIG. 1) and as may be performed by a BS (e.g., 101-103 as illustrated in FIG. 1). An embodiment of the method 1300 shown in FIG. 13A is for illustration only. One or more of the components illustrated in FIG. 13A can be implemented in specialized circuitry configured to perform the noted functions or one or more of the components can be implemented by one or more processors executing instructions to perform the noted functions.

In one example in FIG. 13A, SL data (e.g., PSCCH/PSSCH) is transmitted over the unlicensed spectrum, the SL HARQ feedback on PSFCH is transmitted over licensed/ITS spectrum. In Mode 1, a gNB performs the scheduling over the SL interface through a DCI format 3-0, sent from the gNB to the first UE performing SL transmission. Alternatively, an eNB can signal the first UE to perform a SL transmission.

Before scheduling the SL transmission over SL interface, the gNB or eNB performs LBT operation. If the channel is available, the gNB transmits DCI Format 3-0 to the first UE to perform a SL transmission over the unlicensed spectrum or eNB signals the first UE to perform a SL transmission over the unlicensed spectrum. The transmission from the gNB (e.g., DCI Format 3-0) or the eNB to the UE can be over unlicensed spectrum or over licensed spectrum. If over licensed spectrum, the UE can perform a separate transmission over the unlicensed spectrum following the successful LBT operation.

The first UE transmits, to one or more second UEs, SL data including PSCCH and the corresponding PSSCH over the unlicensed spectrum, using the LBT result of gNB or eNB (shared channel occupancy time (COT) between gNB or eNB and the first UE). Alternatively, the first UE can access the channel by performing a second LBT before sending the SL data.

The one or more second UEs provide HARQ feedback on PSFCH over the licensed/ITS spectrum to the first UE.

The first UE can provide the HARQ-ACK feedback to the gNB or eNB (e.g., in a Physical Control Uplink Channel (PUCCH) or in a Physical Shared Uplink Channel (PUSCH), in one example PUSCH is used when a transmission of PUCCH overlaps a transmission of PUSCH). In one example, the provision of the HARQ-ACK feedback to the gNB or eNB is over licensed spectrum. In one example, the provision of the HARQ-ACK feedback to the gNB or eNB is over unlicensed spectrum

FIG. 13A illustrates an example of processing in a gNB or an eNB and a first UE for transmission of SL information over the unlicensed spectrum.

In Step 1302, the gNB or the eNB determines resources for SL transmission from a first UE over unlicensed spectrum.

In Step 1304, the gNB or the eNB performs LBT e.g., for transmission of a DCI to the first UE over licensed spectrum.

In step 1306, if the LBT is successful, the gNB or the eNB transmits DCI on Uu interface over the unlicensed spectrum. Alternatively, the DCI on Uu interface can be transmitted over licensed spectrum. The first UE receives the DCI in step 1308.

In step 1310, the first UE uses the Channel Occupancy Time (COT) of the gNB or eNB or performs listen-before-talk (LBT) for transmission over SL resource indicated by gNB or eNB.

In step 1312, if using COT of gNB or eNB, or if LBT is successful, transmit (PSCCH/PSSCH) in the unlicensed spectrum.

In Step 1314: The first UE receives HARQ-ACK feedback in a corresponding PSFCH in the licensed spectrum.

In step 1316, the first UE transmits the HARQ-ACK feedback to the gNB or eNB. The transmission can be in licensed or unlicensed spectrum. If transmission is in unlicensed spectrum, the first UE can perform LBT before transmission of the HARQ-ACK feedback to the gNB or eNB, alternative, the first UE can use a COT of the gNB or eNB. gNB or eNB receives the HARQ-ACK feedback in step 1318.

FIG. 13B illustrates an example of SL data channels are transmitted over licensed/ITS spectrum 1350 according to embodiments of the present disclosure. An embodiment of the SL data channels are transmitted over licensed/ITS spectrum 1350 shown in FIG. 13B is for illustration only. As illustrated in FIG. 13B, SL data (e.g., PSCCH/PSSCH) is transmitted over the unlicensed spectrum, the SL HARQ feedback on PSFCH is transmitted over licensed/ITS spectrum.

In one example, there is no HARQ feedback, e.g., the UE can use blind retransmissions, and, in this case, there is no PSFCH transmission on licensed/ITS spectrum. In a variant example, the PSFCH is transmitted over unlicensed spectrum.

In one example of FIG. 13B, the SL synchronization channels are transmitted over licensed/ITS spectrum. In one example, there is no transmission of SL synchronization channels, the synchronization is provided by GNSS or by the network (gNB/eNB). In one example, the SL synchronization channels are transmitted over unlicensed spectrum.

FIG. 14 illustrates yet another example of SL data transmission over the unlicensed spectrum 1400 according to embodiments of the present disclosure. An embodiment of the SL data transmission over the unlicensed spectrum 1400 shown in FIG. 14 is for illustration only.

In one example in FIG. 14, SL data (e.g., PSSCH) is transmitted over the unlicensed spectrum, the SL HARQ feedback on PSFCH is transmitted over licensed/ITS spectrum. In a variant example, the PSFCH is transmitted over unlicensed spectrum. In Mode 1, the gNB performs the scheduling over the SL interface through a DCI Format 3-0, sent from the gNB to the first UE performing SL transmission. Alternatively, the eNB can signal the first UE to perform a SL transmission.

Before scheduling the SL transmission over SL interface, the gNB or eNB performs LBT operation. If the channel is available, the gNB transmits DCI Format 3-0 to the first UE to perform a SL transmission over the unlicensed spectrum or eNB signals the first UE to perform a SL transmission over the unlicensed spectrum. The transmission from the gNB (e.g., DCI Format 3-0) or the eNB to the UE can be over unlicensed spectrum or over licensed spectrum. If over licensed spectrum, the UE can perform a separate transmission over the unlicensed spectrum following the successful LBT operation.

The first UE transmits, to one or more second UEs, the PSCCH associated with SL data on licensed/ITS spectrum. The first UE transmits, to one or more second UEs, PSSCH with the SL data over the unlicensed spectrum, using the LBT result of gNB or eNB (shared Channel Occupancy Time (COT) between gNB or eNB and the first UE). Alternatively, the first UE can access the channel by performing a second LBT before sending the SL data on PSSCH and its corresponding PSCCH.

The one or more second UEs provide HARQ feedback on PSFCH over the licensed/ITS spectrum to the first UE. In a variant example, the PSFCH is transmitted over unlicensed spectrum.

The first UE can provide the HARQ-ACK feedback to the gNB or eNB. In one example, the provision of the HARQ-ACK feedback to the gNB or eNB is over licensed spectrum. In one example, the provision of the HARQ-ACK feedback to the gNB or eNB is over unlicensed spectrum.

In one example, there is no HARQ feedback, e.g., the UE can use blind retransmissions, and, in this case, there is no PSFCH transmission on licensed/ITS spectrum.

In one example of FIG. 14, the SL synchronization channels are transmitted over licensed/ITS spectrum. In one example, there is no transmission of SL synchronization channels, the synchronization is provided by GNSS or by the network (gNB/eNB). In one example, the SL synchronization channels are transmitted over unlicensed spectrum

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive and transmit on a first air interface, wherein the first air interface is for unlicensed spectrum,
receive and transmit on a second air interface, wherein the second air interface is for licensed spectrum; and
a processor operably coupled to the transceiver, the processor configured to determine a slot for a sidelink (SL) transmission of a first physical sidelink shared channel (PSSCH) based on a sensing and listen-before-talk (LBT) operation on the first air interface,
wherein the transceiver is further configured to:
transmit, on the first air interface, the first PSSCH, and
receive, on the second air interface, a first physical sidelink feedback channel (PSFCH) with HARQ-ACK information in response to the first PSSCH.

2. The UE of claim 1, wherein the transceiver is further configured to:
receive, on the first air interface, a second PSSCH, and
transmit, on the second air interface, a second PSFCH in response to the received second PSSCH.

3. The UE of claim 1, wherein the transceiver is further configured to transmit, on the second air interface, a SL-synchronization signal block (S-SSB).

4. The UE of claim 1, wherein the transceiver is further configured to receive, on the second air interface, a SL-synchronization signal block (S-SSB).

5. The UE of claim 1, wherein the transceiver is further configured to:
transmit, on the second air interface, a second PSSCH, and
transmit, on the second air interface, a physical sidelink control channel (PSCCH), wherein the PSCCH is associated with the first PSSCH and the second PSSCH.

6. The UE of claim 1, wherein the transceiver is further configured to:
transmit, on the second air interface, a second PSSCH,
transmit, on the first air interface, a first physical sidelink control channel (PSCCH), wherein the first PSCCH is associated with the first PSSCH, and
transmit, on the second air interface, a second PSCCH, wherein the second PSCCH is associated with the second PSSCH.

7. The UE of claim 1, wherein the transceiver is further configured to receive, on the second air interface, a second PSFCH with conflict information associated with the first PSSCH.

8. The UE of claim 1, wherein:
the transceiver is further configured to receive, on the second air interface, a second PSSCH, and
the second PSSCH includes inter-UE co-ordination information for the first PSSCH.

9. The UE of claim 1, wherein the transceiver is further configured to:
receive, from a base station, a downlink control information (DCI) format with information related to a transmission of a second PSSCH, and
transmit, on the first air interface, the second PSSCH using a channel occupancy time (COT) of the base station.

10. A method of operating a user equipment (UE), the method comprising:
determining a slot for a sidelink (SL) transmission of a first physical sidelink shared channel (PSSCH) based on a sensing and listen-before-talk (LBT) operation on a first air interface, wherein the first air interface is for unlicensed spectrum;
transmitting the first PSSCH on the first air interface; and
receiving, on a second air interface, a first physical sidelink feedback channel (PSFCH) with HARQ-ACK information in response to the first PSSCH, wherein the second air interface is for licensed spectrum.

11. The method of claim 10, further comprising:
receiving, on the first air interface a second PSSCH, and
transmitting, on the second air interface, a second PSFCH in response to the received second PSSCH.

12. The method of claim 10, further comprising transmitting, on the second air interface, a SL-synchronization signal block (S-SSB).

13. The method of claim 10, further comprising receiving, on the second air interface, a SL-synchronization signal block (S-SSB).

14. The method of claim 10, further comprising:
transmitting, on the second air interface, a second PSSCH; and
transmitting, on the second air interface, a physical sidelink control channel (PSCCH), wherein the PSCCH is associated with the first PSSCH and the second PSSCH.

15. The method of claim 10, further comprising:
transmitting, on the second air interface, a second PSSCH;
transmitting, on the first air interface, a first physical sidelink control channel (PSCCH), wherein the first PSCCH is associated with the first PSSCH; and
transmitting, on the second air interface, a second PSCCH, wherein the second PSCCH is associated with the second PSSCH.

16. The method of claim 10, further comprising receiving, on the second air interface, a second PSFCH with conflict information associated with the first PSSCH.

17. The method of claim 10, further comprising receiving, on the second air interface, a second PSSCH, wherein the second PSSCH includes inter-UE co-ordination information for the first PSSCH.

18. The method of claim 10, further comprising:
receiving, from a base station, a downlink control information (DCI) format with information related to a transmission of a second PSSCH; and
transmitting, on the first air interface, the second PSSCH using a channel occupancy time (COT) of the base station.

19. A base station (BS), comprising:
a transceiver configured to receive and transmit at least on a first air interface, wherein the first air interface is for unlicensed spectrum; and
a processor operably coupled to the transceiver, the processor configured to determine a slot for a sidelink (SL) transmission of a physical sidelink shared channel (PSSCH) for a user equipment (UE),
wherein the transceiver is further configured to:
perform a listen-before-talk (LBT) operation on the first air interface, and
if the LBT operation is successful, transmit a downlink control information (DCI) format to the UE with information about the SL transmission of the PSSCH.

20. The base station of claim 19, wherein a channel occupancy time (COT) is initiated by the base station and is shared with the UE for the SL transmission of the PSSCH.
